(19) United States
(12) Patent Application Publication
(10) Pub. No.: US 2013/0244892 A1
(43) Pub. Date: Sep. 19, 2013

(54) Risk Factors and Prediction of Adverse Events

(71) Applicants: Aram S. Adourian, Concord, MA (US); Yu Guo, Lunenburg, MA (US); Xiaohong Li, Acton, MA (US); Pieter Muntendam, Boxford, MA (US)

(72) Inventors: Aram S. Adourian, Concord, MA (US); Yu Guo, Lunenburg, MA (US); Xiaohong Li, Acton, MA (US); Pieter Muntendam, Boxford, MA (US)

(21) Appl. No.: 13/765,366

(22) Filed: Feb. 12, 2013

Related U.S. Application Data
(60) Provisional application No. 61/597,810, filed on Feb. 12, 2012.

(51) Int. Cl. G06F 19/00

(52) U.S. Cl. CPC G06F 19/345
USPC 506/9; 436/501; 435/7.1; 435/6.12; 435/6.11; 702/19; 702/21

(57) ABSTRACT

Biomarkers, methods, systems, and related teachings are disclosed for diagnosing the risk of an adverse event in a human, where the adverse event can be unstable angina, ischemic stroke, non-ischemic stroke, all-cause stroke, heart failure, all-cause death, and being a candidate for coronary revascularization surgery.

### REFERENCE TO RELATED APPLICATIONS

This application claims priority to and the benefit of U.S. Provisional Patent Application No. 61/597,810, filed on Feb. 12, 2012, the entire contents of which are incorporated by reference herein.

### BACKGROUND

Health care costs are increasing annually. Early detection and diagnosis of individuals at risk for adverse health events such as unstable angina, ischemic stroke, non-ischemic stroke, all-cause stroke, heart failure, and all-cause death, as well as being a candidate for coronary revascularization surgery, permits effective treatment to be initiated early, thereby saving costs to the healthcare system in the long term.

Thus, there is a need to improve both the detection and the treatment of individuals at highest risk for adverse health events such as unstable angina, ischemic stroke, non-ischemic stroke, all-cause stroke, heart failure, and all-cause death, as well as being a candidate for coronary revascularization surgery.

### SUMMARY

Sets of biomarkers have been discovered that are predictive of the risk that an individual, i.e., a human, will experience unstable angina, ischemic stroke, non-ischemic stroke, all-cause stroke, heart failure, or all-cause death, or will be a candidate for coronary revascularization surgery. In particular, the sets of biomarkers identified herein have been discovered to provide superior discriminatory power as compared to traditional clinical risk factors (e.g., age, smoking status, and cholesterol levels) for predicting whether a human will experience unstable angina, ischemic stroke, non-ischemic stroke, all-cause stroke, heart failure, or all-cause death, or be a candidate for coronary revascularization surgery. Although each of these clinical endpoints (or indications) independently has been associated with the disclosed sets of biomarkers (or biomarker panels), for convenience and brevity, each of the indications herein is referred to individually, and collectively, as an “adverse event,” for which one or more of the specifically recited indications can be substituted. That is, for the avoidance of doubt, whenever the phrase “adverse event” is used, one of more of the following may be substituted for “adverse event” unstable angina, ischemic stroke, non-ischemic stroke, all-cause stroke, heart failure, all-cause death, and being a candidate for coronary revascularization surgery, unless otherwise understood by the context of the teachings herein.

More specifically, in various embodiments of the present teachings, the set of biomarkers includes carcinoembryonic antigen (CEA), beta-2 microglobulin, C reactive protein (CRP), apolipoprotein A1 (ApoA1), apolipoprotein B (ApoB), transferrin, and lipoprotein(a). In some embodiments, the set of biomarkers also can include N-terminal pro B-type natriuretic peptide (NT-proBNP).

Thus, in one aspect, the present teachings provide methods for diagnosing the risk of an adverse event in a human. The methods generally can include measuring the levels of a set of biomarkers in a sample from a human, where the set of biomarkers includes carcinoembryonic antigen (CEA), beta-2 microglobulin, C-reactive protein (CRP), apolipoprotein A1 (ApoA1), apolipoprotein B (ApoB), transferrin, and lipoprotein(a), and optionally N-terminal pro B-type natriuretic peptide (NT-proBNP); calculating a risk score for the human including weighting measured levels of biomarkers; and using the risk score to identify a likelihood that the human will experience an adverse event.

In some embodiments, the methods of diagnosing the risk of an adverse event in a human can include receiving the measured levels of a set of biomarkers, where the measured levels are from a sample obtained from a human and the set of biomarkers includes carcinoembryonic antigen (CEA), beta-2 microglobulin, C-reactive protein (CRP), apolipoprotein A1 (ApoA1), apolipoprotein B (ApoB), transferrin, and lipoprotein(a), and optionally N-terminal pro B-type natriuretic peptide (NT-proBNP); calculating a risk score for the human, where calculating the risk score comprises weighting the measured levels of biomarkers; and using the risk score to identify a likelihood that the human will experience an adverse event.

In various embodiments of the present teachings, the methods of diagnosing an adverse event in a human generally can include inputting into a computer including a computer readable medium measurements of the levels of a set of biomarkers in a sample obtained from a human; and causing the computer to calculate a risk score for the human by weighting the measured levels of biomarkers, thereby determining the risk of an adverse event in the human. The set of biomarkers can include carcinoembryonic antigen (CEA), beta-2 microglobulin, C-reactive protein (CRP), apolipoprotein A1 (ApoA1), apolipoprotein B (ApoB), transferrin, and lipoprotein(a). In various embodiments, the set of biomarkers also can include N-terminal pro B-type natriuretic peptide (NT-proBNP).

The methods described herein including those above can include transmitting, displaying, storing, or printing; or outputting to a user interface device, a computer readable storage medium, a local computer system or a remote computer system, information related to the likelihood of an adverse event in the human. The methods also can include recommending, authorizing, or administering treatment if the human is identified as having an increased likelihood of experiencing an adverse event. Various features and steps of the methods of the present teachings can be carried out with or assisted by a suitably programmed computer, specifically adapted, designed and/or structured to do so.

In some embodiments, calculating a risk score includes transforming logarithmically the measured levels of the biomarkers to generate a transformed value for each measured biomarker; multiplying the transformed value of each biomarker by a biomarker constant to generate a multiplied value for each biomarker; and summing the multiplied value of each biomarker to generate the risk score. The calculating can include transforming logarithmically the measured levels of each biomarker measured or only a subset thereof, where the non-logarithmically transformed biomarkers can be assigned a constant value associated with its measured level or other mathematical expression for use in calculating a risk score.

In certain embodiments of the present teachings, calculating a risk score includes transforming logarithmically measured levels of biomarkers to generate a transformed value for the respective measured biomarker. Calculating a risk score can include multiplying a transformed value of a biomarker by a biomarker constant to generate a multiplied value for the respective biomarker. Calculating a risk score also can include summing the multiplied values of biomarkers to generate the risk score. In various embodiments, calculating a risk score can include using a constant associated with a measured level of a biomarker, which constant can be indicative of the measured level of the biomarker. For example, depending on the measured level of the biomarker, a different constant can be used for that biomarker in the calculating of a risk score, such as in summing values to generate a risk score. In certain embodiments, calculating the risk score can include summing the multiplied values of the biomarkers, the constant(s) associated with other biomarkers, and an additional constant. In particular embodiments, the sum of the one or more of the above-identified values and constants can be multiplied by another constant.

A risk score can be compared to a reference risk score (or standard risk score). A reference risk score can be a standard or a threshold. The threshold can be a lower threshold, an upper threshold, or a threshold having an upper limit and a lower limit.

In another aspect, the present teachings include a computer readable storage medium including program instructions for use in performing a method of diagnosing the risk of an adverse event in a human, wherein execution of the program instructions by one or more processors of a computer system causes the one or more processors to carry out the step of calculating a risk score for a human including weighting measured levels of biomarkers and summing weighted measured levels. The measured levels of biomarkers can be determined in a sample obtained from the human. The set of biomarkers includes carcinoembryonic antigen (CEA), beta-2 microglobulin, C-reactive protein (CRP), apolipoprotein A1 (ApoA1), apolipoprotein B (ApoB), transferrin, and lipoprotein(a), and optionally N-terminal pro B-type natriuretic peptide (NT-proBNP).

In yet another aspect, the present teachings provide systems and kits for diagnosing the risk of an adverse event in a human. A system can include a sample collection device adapted to obtain a sample from a human; an analytical instrument adapted to measure the levels of a set of biomarkers in a sample from a human, where the sample collection device collected or obtained the sample from the human and the set of biomarkers comprises carcinoembryonic antigen (CEA), beta-2 microglobulin, C-reactive protein (CRP), apolipoprotein A1 (ApoA1), apolipoprotein B (ApoB), transferrin, and lipoprotein(a), and optionally N-terminal pro B-type natriuretic peptide (NT-proBNP); and a suitably programmed computer adapted to calculate a risk score for the human, wherein calculating the risk score comprises weighting the measured levels of biomarkers. The measured levels of the biomarkers can be the measured levels of a set of biomarkers in a sample obtained from the human as measured by the analytical instrument.

Kits also are provided for diagnosing the risk of an adverse event in a human. The kit can include a set of reagents that specifically measures the levels of a set of biomarkers in a sample from a human, and instructions for using the kit for diagnosing the risk of an adverse event.

The foregoing as well as other features and advantages of the present teachings will be more fully understood from the following figure, description, examples, and claims.

### DESCRIPTION OF DRAWING

It should be understood that the drawing described below is for illustration purposes only. The drawing is not intended to limit the scope of the present teachings in any way.

FIG. 1 is a histogram showing the distribution of Risk Score1 values among the 6,600 individuals in a clinical study.

### DETAILED DESCRIPTION

Sets of biomarkers have been discovered that are predictive of the risk that an individual, i.e., a human (with these terms used interchangeably herein along with the term “subject”) will suffer a future adverse event. A “biomarker” can be any biological feature or variable whose qualitative or quantitative presence, absence, or level in a biological system of a human is an indicator of a biological state of the system. Accordingly, biomarkers can be useful to assess the health state or status of a human. For example, multiple biomarker levels can be analyzed using a weighted analysis or algorithm to generate a risk score for a human. The risk score can be indicative of the likelihood that the human will suffer a future adverse event. In some embodiments, the magnitude of the risk score can be correlated to the level of risk for that human. For example, a higher risk score can be indicative of a higher likelihood of a future adverse event, while a lower risk score can be indicative of a lower likelihood of a future adverse event.

The present teachings can be used to identify individuals who appear healthy but may be at risk for experiencing an adverse event. Armed with this information, individuals at risk can take proactive steps such as exercising, dieting, and/or seeking medical intervention to reduce the likelihood of suffering an adverse event in the future. Thus, the present teachings can be used more accurately to predict future adverse events and possibly save lives. In addition, the present teachings can be used to monitor disease status or disease progression in a human.

The sets of biomarkers described herein can be useful, alone or in combination with other biomarkers and/or clinical risk factors, to measure the initiation, progression, severity, pathology, aggressiveness, grade, activity, disability, mortality, morbidity, disease sub-classification or other underlying feature of one or more biological processes, pathogenic processes, diseases, or responses to therapeutic intervention in connection with an adverse event. Virtually any biological compound that is present in a sample and that can be isolated from, or measured in, the sample can be used as a biomarker. Non-limiting examples of classes of biomarkers include a polypeptide, a protein, a proteoglycan, a glycoprotein, a lipoprotein, a carbohydrate, a lipid, a nucleic acid, an organic on inorganic chemical, a natural polymer, a metabolite, and a small molecule. A biomarker also can include a physical measurement of the human body, such as blood pressure and cell counts, as well as the ratio or proportion of two or more biological features or variables. In some embodiments, biomarkers from different biological categories can be selected to generate the risk score. Non-limiting examples of different biological categories include inflammation-sensitive plasma proteins, apolipoproteins, markers of iron overload, growth factors, and leukocyte counts.

Throughout the application, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

The “level” or “amount” of a biomarker can be determined by any method known in the art and will depend in part on the nature of the biomarker. For example, the biomarkers levels can be measured by one of more of an immunoassay, a colorimetric assay, a turbidimetric assay, and flow cytometry. It is understood that the amount of the biomarker need not be determined in absolute terms, but can be determined in relative terms. In addition, the amount of the biomarker can be expressed by, for example, its concentration in a biological sample, by the concentration of an antibody that binds to the biomarker, or by the functional activity (i.e., binding or enzymatic activity) of the biomarker.

As used herein, “reference” or “control” or “standard” each can refer to an amount of a biomarker in a healthy individual or control population or to a risk score derived from one or more biomarkers in a healthy individual or control population. The amount of a biomarker can be determined from a sample of a healthy individual, or can be determined from samples of a control population.

As used herein, “sample” refers to any biological sample taken from a human, including blood, blood plasma, blood serum, cerebrospinal fluid, bile acid, saliva, synovial fluid, pleural fluid, pericardial fluid, peritoneal fluid, sweat, feces, nasal fluid, ocular fluid, intracellular fluid, intercellular fluid, lymph urine, tissue, liver cells, epithelial cells, endothelial cells, kidney cells, prostate cells, blood cells, lung cells, brain cells, adipose cells, tumor cells, and mammary cells. The sources of biological sample types may be different subjects; the same subject at different times; the same subject in different states, e.g., prior to drug treatment and after drug treatment; different sexes; different species, for example, a human and a non-human mammal; and various other permutations. Further, a biological sample type may be treated differently prior to evaluation such as using different work-up protocols.

The present teachings generally provide a method for diagnosing the risk of an adverse event, for example, the near-term risk of an adverse event, in an individual such as a human or subject. As used herein, “near-term” means within about zero to about six years from a baseline, where baseline is defined as the date on which a sample from a human is taken for analysis. For example, near-term includes within about one week, about one month, about two months, about three months, about six months, about nine months, about one year, about two years, about three years, about four years, about five years, or about six years from a baseline. As used herein, “near-term risk” means the risk that a human will experience an adverse event within the near-term.

In various embodiments, the methods generally include measuring the levels (or using the measured levels) of a set of biomarkers in a sample obtained from a human; calculating a risk score for the human, including weighting measured levels of biomarkers; and using the risk score to identify a likelihood that the human will experience an adverse event (e.g., identifying, based on the risk score, a likelihood of an adverse event in the human).

In some embodiments, the methods include calculating a risk score, using a suitably programmed computer, based on the measured levels of one or more biomarkers. In certain embodiments, the methods include transmitting, displaying, storing, or printing—or outputting to a user interface device, a computer readable storage medium, a local computer system, or a remote computer system—information related to the likelihood of an adverse event in the individual. Information can include, but is riot limited to, a measured level of one or more biomarkers, a risk score, a likelihood of an adverse event, a reference risk score, and equivalents thereof (all of which can include or be, e.g., a graph, a figure, a symbol, and the like), and any other data related to the methods described herein.

In some embodiments, methods of diagnosing the risk of an adverse event in a human can include receiving the measured levels of a set of biomarkers, wherein the measured levels are from a sample obtained from a human and the set of biomarkers comprises carcinoembryonic antigen (CEA), beta-2 microglobulin, C-reactive protein (CRP), apolipoprotein A1 (ApoA1), apolipoprotein B (ApoB), transferrin, and lipoprotein(a). The method can include calculating a risk score for the human, where calculating the risk score comprises weighting measured levels of biomarkers; and using the risk score to identify a likelihood that the human will experience an adverse event.

In certain embodiments, the present teachings provide methods of diagnosing the risk of an adverse event in a human, for example, a method comprising inputting into a computer including a computer readable medium measurements of the levels of a set of biomarkers in a sample obtained from a human, wherein the set of biomarkers comprises carcinoembryonic antigen (CEA), beta-2 microglobulin, C-reactive protein (CRP), apolipoprotein A1 (ApoA1), apolipoprotein B (ApoB), transferrin, and lipoprotein(a); and causing the computer to calculate a risk score for the human, wherein calculating comprises weighting measured levels of biomarkers thereby determining the risk of an adverse event in the human.

In various embodiments described herein including those above, the methods use a set of biomarkers including carcinoembryonic antigen (CEA), beta-2 microglobulin, C-reactive protein (CRP), apolipoprotein A1 (ApoA1), apolipoprotein B (ApoB), transferrin, and lipoprotein(a).

In particular embodiments described herein including those above, the methods use a set of biomarkers including carcinoembryonic antigen (CEA), beta-2 microglobulin, C-reactive protein (CRP), apolipoprotein A1 (ApoA1), apolipoprotein B (ApoB), transferrin, lipoprotein(a), and NT-proBNP.

The levels of biomarkers can be determined by a variety of techniques known in the art, dependent, in part, on the nature of the biomarker. For example, the level of a biomarker can be determined by at least one of an immunoassay, spectrophotometry, an enzymatic assay, an ultraviolet assay, a kinetic assay, an electrochemical assay, a colorimetric assay, a turbidimetric assay, an atomic absorption assay, and flow cytometry. Other analytical techniques such as mass spectrometry, liquid chromatography such as high performance/pressure liquid chromatography (HPLC), gas chromatography, nuclear magnetic resonance spectrometry, related techniques and combinations and hybrids thereof, for example, a tandem liquid chromatography-mass spectrometry (LC-MS) instrument can be used as appropriate.

In some embodiments, calculating a risk score includes transforming logarithmically the measured levels of the biomarkers to generate a transformed value for each measured biomarker; multiplying the transformed value of each biomarker by a biomarker constant to generate a multiplied value for each biomarker; and summing the multiplied value of each biomarker to generate the risk score. Of course other means known to those skilled in the art can be used to calculate a risk score or similar score based on the measured levels of the set of biomarkers, which risk score or similar score can be predictive of a likelihood of a human experiencing an adverse event.

Consequently, in certain embodiments of the present teachings, calculating a risk score includes transforming logarithmically measured levels of biomarkers to generate a transformed value for the respective measured biomarker. Calculating a risk score can include multiplying a transformed value of a biomarker by a biomarker constant to generate a multiplied value for the respective biomarker. Calculating a risk score also can include summing the multiplied values of biomarkers to generate the risk score.

In various embodiments, calculating a risk score can include using a constant associated with a measured level of a biomarker, which constant can be indicative of the measured level of the biomarker. For example, depending on the measured level of the biomarker, a different constant can be used for that biomarker in the calculation of a risk score, for example, in the summing of values to generate a risk score. In certain embodiments, calculating the risk score can include summing the multiplied values of the biomarkers, the constant(s) associated with other biomarkers, and an additional constant to generate a risk score. In particular embodiments, the sum of the one or more of the above-identified values and constants can be multiplied by another constant to generate a risk score. It should be understood that the calculating of a risk score can include various combinations of weighting, multiplying, summing, and the use of constants including constants that are associated with different levels of a measured biomarker level, as taught and described herein.

A risk score can be compared to a reference risk score (or standard risk score). A reference risk score can be a standard (e.g., a number) or a threshold (e.g., a line on a graph), such as an upper threshold or a lower threshold. A threshold also can have an upper limit and a lower limit. In certain embodiments, if a risk score is greater than a reference risk score, the individual can have an increased likelihood of experiencing an adverse event, for example, a future adverse event. In some embodiments, if a risk score is less than a reference risk score, the individual can have a decreased likelihood of experiencing an adverse event, for example, a future adverse event.

In some embodiments, the magnitude of individual's risk score, or the amount by which it exceeds a reference risk score, can be indicative of or correlated to that individual's level of risk. For example, a higher risk score can be indicative of a higher likelihood of a future adverse event, while a lower risk score can be indicative of a lower likelihood of a future adverse event. Conversely, if the individual's risk score is below a reference risk score, the individual may not be at significant risk for experiencing a future adverse event.

Establishing a reference risk score, standard, threshold, decision boundary, or a “cutoff” score (referenced herein typically as a “reference risk score”) for a particular set of biomarkers is known in the art. See e.g., Szklo, Moyses and Nieto, F. Javier, Epidemiology: beyond the basics, 2nd Ed. (Sudbury, Mass.: Jones and Bartlett Publishers (2007)); Schlesselman, J. J., Case-Control Studies, (New York: Oxford University Press (1982)); Anderson K. M., Odell P. M., Wilson P. W., Kannel W. B., “Cardiovascular disease risk profiles,” Am. Heart J. 121:293-8 (1991); Eichler K., Puhan M. A., Steiner J., Bachmann L. M., “Prediction of first coronary events with the Framingham score: a systematic review,” Am. Heart J. 153(5):722-31, 731,e1-8 (2007); and Hoffmann U., Massaro J. M., Fox. C. S., Manders E., O'Donnell C. J. “Defining normal distributions of coronary artery calcium in women and men from the Framingham Heart Study,” Am. J. Cardiol. 102(9):1136-41 1141.e1. (2008).

The methods of the present teachings permit not only the diagnosis of a likelihood or a risk of a future adverse event, for example, a near-term adverse event, but also can include recommending, authorizing, or administering treatment if the human is identified as having an increased likelihood of an adverse event. In some embodiments of the methods, information related to the likelihood of an adverse event of a human can be transmitted to a person in a medical industry, a medical insurance provider, a health care provider, or to a physician.

Moreover, the same methodology used to identify a human as being at an increased likelihood of experiencing an adverse event can be adapted to other uses. For example, a risk score can be used to screen candidate drugs that mitigate the causative factors which lead to adverse event. In this instance, treatment with candidate drugs can be monitored by monitoring biomarker levels and/or the risk score. Moreover, with any drug that has already been found effective to reduce the likelihood of a future adverse event, it can be that certain individuals may be responders and some may be non-responders. Accordingly, an individual's risk score could be monitored during treatment to determine if the drug is effective. For example, if the individual's risk score decreases in response to treatment, the individual may be responding to the treatment and therefore also may be at a decreased risk for experiencing a future event. Of course, there may not be any existing, known population of responders and non-responders so that the efficacy of drug treatment with respect to any future adverse event in an individual should be and can be monitored over time. To the extent the drug is not efficacious, its use can be discontinued and another drug supplied in its place.

The risk score can be calculated as described herein using a suitably programmed computer, which can include other electronic devices. In addition, that or another suitably programmed computer can compare the risk score to a reference risk score for purposes of determining a likelihood that the individual will experience an adverse event. Suitable programming can include, for example, software, firmware, or other program code that enables the computer to process, analyze, and/or convert measured biomarker levels into a risk score, and to interpret the likelihood of an adverse event based on the risk score. Such programming can be included within the computer, or can be embodied on a computer readable medium such as a portable computer readable medium. Of course, other steps or processes of the present teachings can be carried out using or can be assisted by a suitably programmed computer, for example, the measuring of the levels of biomarkers, the using of a risk score, the recommending and/or authorizing of treatment, and the transmitting, displaying, storing, printing, and/or outputting of information.

After a risk score and/or a likelihood of an adverse event is determined, information about the risk score and/or a likelihood of a future adverse event in a human can be displayed or outputted to a user interface device, a computer readable storage medium, or a local or remote computer system. Such information can include, for example, the measured levels of one or more biomarkers, a risk score, a likelihood of an adverse event, a reference risk score, and equivalents thereof (all of which can include or be, e.g., a graph, a figure, a symbol, and the like), and any other data related to the methods described herein. Displaying or outputting information means that the information is communicated to a user using any medium, for example, orally, in writing, on a printout, by visual display computer readable medium, computer system, or other electronic device (e.g., smart phone, personal digital assistant (PD), laptop, etc.). It will be clear to one skilled in the art that outputting information is not limited to outputting to a user or a linked external component(s), such as a computer system or computer memory, but can alternatively or additionally be outputted to internal components, such as any computer readable medium.

Computer readable media can include, but are not limited to, hard drives, floppy disks, CD-ROMs, DVDs, and DATs. Computer readable media does not include carrier waves or other wave forms for data transmission. It will be clear to one skilled in the art that the various sample evaluation and diagnosis methods disclosed and claimed herein, can, but need not be, computer-implemented, and that, for example, the displaying or outputting step can be done by, for example, by communicating to a person orally or in writing (e.g., in handwriting).

According to various embodiments, at least one of a risk score, a likelihood of an adverse event, measured biomarker levels, a reference risk score, and equivalents thereof, can be displayed on a screen or a tangible medium. In certain embodiments, such information can be transmitted to a person in a medical industry, a medical insurance provider, a health care provider, or to a physician.

In yet another aspect, the present teachings include systems and kits useful for performing the diagnostic methods described herein. The methods described herein can be performed, for example, by diagnostic laboratories, service providers, experimental laboratories, and individuals. The systems and kits described herein can be useful in these settings, among others.

Accordingly, in various embodiments, the present teachings provide a system for performing the methods disclosed herein. The system can include a sample collection device for obtaining a sample from a human. The system can include an analytical instrument used to measure the levels of a set of biomarkers, for example, in a sample obtained from a human using the sample collection device. The system also can include a suitably programmed computer for carrying out one or more steps of the methods. For example, the suitably programmed computer can carry out or assist in one or more of measuring the levels of a set of biomarkers in a sample from a human; calculating a risk score by the various techniques taught herein or known in the art; using the risk score to indentify a likelihood that a human will experience an adverse event; and displaying information related to the likelihood of an adverse event such as the measured biomarker levels, the risk score, the likelihood of an adverse event, a reference risk score, and equivalents thereof.

In certain embodiments, kits can include reagents and materials for measuring the levels of one or more biomarkers in a sample from a human, analyzing the measured levels, and identifying whether the individual is at risk for an adverse event. For example, in some embodiments, the kit can include a sample collection device such as a needle, syringe, vial, or other apparatus for obtaining and/or containing a sample from a human. In some embodiments, the kit can include at least one reagent which is used specifically to detect or quantify a biomarker disclosed herein. That is, suitable reagents and techniques readily can be selected by one of skill in the art for inclusion in a kit for detecting or quantifying those biomarkers.

For example, where the biomarker is a protein, the kit can include reagents (e.g., an antibody) appropriate for detecting proteins using, for example, an immunoassay (e.g., chemiluminescent immunoassay), a colorimetric assay, or a turbidimetric assay. Where the biomarker is a cell, the kit can include reagents appropriate for detecting cells using, for example, flow cytometry. Where the biomarker is an organic or inorganic chemical, lipid, or small molecule, the kit can include reagents appropriate for detecting such biomarkers using, for example, HPLC, enzymatic assays, spectrophotometry, ultraviolet assays, kinetic assays, electrochemical assays, colorimetric assays, atomic absorption assays, and mass spectrometry. Where the biomarker is a nucleic acid (e.g., RNA) or a protein encoded by a nucleic acid, the kit can include reagents appropriate for detecting nucleic acids using, for example, PCR, hybridization techniques, and microarrays.

Depending on the biomarkers to be measured, the kit can include: extraction buffers or reagents, amplification buffers or reagents, reaction buffers or reagents, hybridization buffers or reagents, immunodetection buffers or reagents, labeling buffers or reagents, and detection means.

Kits can also include a control, which can be a control sample, a reference sample, an internal standard, or previously generated empirical data. The control may correspond to a normal, healthy individual or an individual having a known disease status. In addition, a control may be provided for each biomarker or the control may be a reference risk score.

Kits can include one or more containers for each individual reagent. Kits can further include instructions for performing the methods described herein and/or interpreting the results, in accordance with any regulatory requirements. In addition, software can be included in the kit for analyzing the detected biomarker calculating a risk score, and/or determining a likelihood of an adverse event. Preferably, the kits are packaged in a container suitable for commercial distribution, sale, and/or use, containing the appropriate labels, for example, labels including the identification of one of more sets of biomarkers described herein.

The following examples are provided to illustrate further and to facilitate the understanding of the present teachings and are not in any way intended to limit the invention,

### EXAMPLE 1

### Blood Plasma Analytes for Prediction of Risk for Coronary Artery Revascularization

### A. Methods

1. Study Population

A clinical study was conducted as follows. Subjects (also referred to herein as “humans” or “individuals”) from the BioImage Study (ClinicalTrials.gov Identifier: NCT00738725) were evaluated. The BioImage study is a large, prospective, observational study that enrolled 7,687 men and women (men 55 to 80 years of age, and women 60 to 80 years of age) without evidence of atherosclerotic or cardiac disease, between January 2008 and June 2009 in the United States. The BioImage study is described in Muntendam P., McCall C., Sang J., Falk E., and Fuster V., “High-Risk Plaque initiative. The BioImage Study: novel approaches to risk assessment in the primary prevention of atherosclerotic cardiovascular disease—study design and objectives'” Am. Heart J. 160:49-57 (2010), and in Sillesen H., Muntendam P., Adourian A., Entrekin R., Garcia M., Falk E., and Fuster V., “Carotid plaque burden as a measure of subclinical atherosclerosis: comparison with other tests for subclinical arterial disease in the High Risk Plaque BioImage study,” JACC Cardiovasc. Imaging. 5:681-9 (2012). Of the 7,687 enrolled subjects, 6,822 subjects were randomly assigned per the study protocol to provide a blood specimen as part of their study procedures the time of enrollment, and the other 865 individuals were assigned to a group that only participated in a telephone survey and did not provide blood specimens. Of the 6,822 subjects assigned per the study protocol to provide a blood specimen, a blood plasma specimen was available for 6,600 subjects. All 6,600 blood plasma specimens were used in the experiment.

The BioImage cohort has been designed to represent a U.S.-based, free-living, community-dwelling population. The socio-demographic characteristics of the enrolled BioImage cohort were further designed to be generally representative of the racial composition of the United States. Study participants were recruited from two different geographic regions: the Chicago, Ill. and the Fort Lauderdale, Fla. metropolitan areas. Subjects at enrollment had no history of coronary heart disease, cerebrovascular disease, or peripheral artery disease. All subjects provided written consent, and the BioImage Study was reviewed and approved by an institutional review board. At the time of the experiment, the median follow-up time in the study was 911 days, or approximately 2.5 years.

2. Biochemical and Clinical Measurements

The individual concentrations of eight analytes were measured in each blood plasma specimen. The eight analytes were the following: apolipoprotein A1, apolipoprotein B, beta-2-microglobulin, carcinoembryonic antigen, C-reactive protein, lipoprotein(a), N-terminal pro B-type natriuretic peptide (NT-proBNP), and transferrin. The analyte NT-proBNP was measured in plasma using a Siemens Dimension Vista® clinical analyzer instrument. The remaining seven plasma analytes were measured using an Abbott ARCHITECT® ci8200 clinical analyzer instrument. In addition, the individual concentrations of the following analytes were measured in each blood plasma specimen: total cholesterol, high-density lipoprotein (HDL) cholesterol, low-density lipoprotein cholesterol (LDL), and total triglyceride.

The following clinical measurements were ascertained for each subject in the experiment: systolic blood pressure, diastolic blood pressure, current smoking status, presence of diabetes mellitus, and body mass index.

The measurements units of each analyte is shown in Table 1, where “mg” means milligram, “ng” means nanogram, ‘pg” means picogram, “mL” means milliliter, “L” means liter, “mmHg” means millimeter of mercury, “dL” means deciliter, “kg” means kilogram, and “m” means meter.

TABLE 1

| | measurement |
|---|---|
| measurement | unit |
| total cholesterol | mg/dL |
| high-density lipoprotein cholesterol | mg/dL |
| low-density lipoprotein cholesterol | mg/dL |
| total triglycerides | mg/dL |
| systolic blood pressure | mmHg |
| diastolic blood pressure | mmHg |
| current smoking status | n/a |
| presence of diabetes mellitus | n/a |
| body mass index | kg/m² |
| apolipoprotein A1 concentration | mg/dL |
| apolipoprotein B concentration | mg/dL |
| beta-2-microglobulin concentration | mg/L |
| C-reactive protein concentration | mg/dL |
| transferrin concentration | mg/dL |
| NT-proBNP concentration | pg/mL |
| lipoprotein(a) concentration | mg/dL |
| carcinoembryonic antigen | ng/mL |
| concentration | |

### B. Results

Among the 6,600 individuals in the study, the mean follow-up duration was 2.5 years. A total of 117 subjects underwent a coronary artery revascularization procedure (including coronary artery bypass graft, and percutaneous coronary intervention) to restore or improve coronary artery blood flow. The concentrations of the following seven analytes were combined to yield a risk score: apolipoprotein A1 (APOA1), apolipoprotein B (APOB), beta-2-microglobulin (B2M), carcinoembryonic antigen (CEA), C-reactive protein (CRP), lipoprotein(a) (LPA), and transferrin (TRF). The equation used to combine analyte levels into a risk score was the following:

“Risk Score1”=2.5*(−3.4257523−1.1252*ln(APOA1)+0.9205*ln(APOB)+1.0627*ln(B2M)+0.1408*ln(CRP)+1.0326*ln(TRF)+a_{LPA}+a_{CEA)}
where

| a_{LPA} is: | if lipoprotein(a) measurement value is: | |
|---|---|---|
| 0 | ≦3.2 | mg/dL |
| 0.5194 | >3.2 and ≦6.9 | mg/dL |
| 0.3703 | >6.9 and ≦11.4 | mg/dL |
| 0.3442 | >11.4 and ≦28.3 | mg/dL |
| 0.6848 | >28.3 | mg/dL |

and

| | if carcinoembryonic antigen | |
|---|---|---|
| a_{CEA} is: | measurement value is: | |
| 0 | ≦1.01 | ng/mL |
| 0.1851 | >1.01 and ≦1.43 | ng/mL |
| 0.0312 | >1.43 and ≦1.93 | ng/mL |
| 0.4171 | >1.93 and ≦2.83 | ng/mL |
| 0.6757 | >2.83 | ng/mL |

and “APOA1” is the measured concentration of apolipoprotein A1 in units of mg/dL, “APOB” is the measured concentration of apolipoprotein B in units mg/dL, “B2M” is the measured concentration of bets-2-microglobulin in units of mg/L, “CRP” is the measured concentration of C-reactive protein in units of mg/dL, and “TRF” is the measured concentration of transferrin in units of mg/dL, and in the above algorithm “ln” indicates natural logarithm, and “*” indicates multiplication. The risk score is a dimensionless real number.

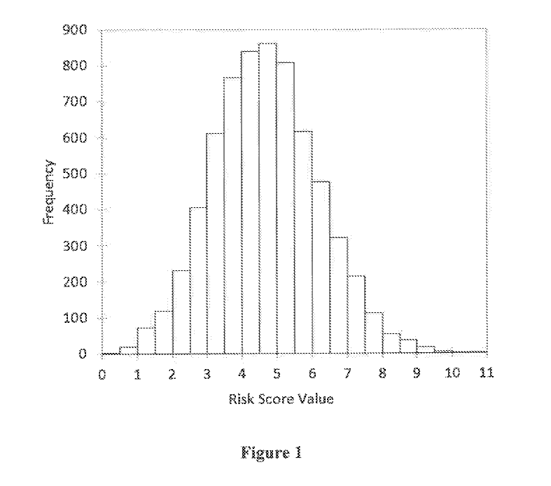

A risk score, referred to herein as “Risk Score1,” was calculated for each of the 6,600 individuals in the study, using measurements from each subject's baseline blood plasma specimen. FIG. 1 is a histogram showing the distribution of Risk Score1 values among the 6,600 individuals in the clinical study.

The value of Risk Score1 was found to be statistically significantly different between the 117 subjects that underwent a coronary artery revascularization procedure at some time, and the remaining 6,483 subjects who did not undergo a coronary artery revascularization procedure. The distribution of Risk Score1 values was as follows (Table 2).

TABLE 2

| | | | Standard |
|---|---|---|---|
| | Observations | Mean | deviation |
| Subjects who did not undergo | 6483 | 4.668 | 1.518 |
| a coronary artery | | | |
| revascularization procedure | | | |
| Subjects who did undergo a | 117 | 5.346 | 1.454 |
| coronary artery | | | |
| revascularization procedure | | | |

A two-sided Student t-test for the difference in mean values of the risk score yielded a t value of −4.795 and 6,598 degrees of freedom, and a p-value <0.0001.

Statistical Cox proportional hazard modeling was used to determine the instantaneous hazard of the occurrence of a coronary artery revascularization procedure at any time per one unit increase in the calculated Risk Score1. For this analysis, the variable Risk Score1 was treated as a continuous variable, and subjects who died were treated as a competing risk in the Cox proportional hazard model according to the procedure described in, for example, in the following reference: Fine, J. P. and Gray, R. J., “A proportional hazards model for the subdistribution of a competing risk,” Journal of the American Statistical Association, 94:496-509 (1999). In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the competing risk Cox proportional hazard model yielded a hazard ratio for the score of 1.26 per unit increase of Risk Score1 (95% confidence interval of 1.08 to 1.47), with a P-value of 0.00303.

In addition, a statistical Cox proportional hazard model was evaluated with the Risk Score1 categorized into three categories. The ranges of Risk Score1 that defined the three categories were as follows: (i) Risk Score1≦3.9; (ii) Risk Score1>3.9 and ≦5.3; (iii) Risk Score1>5.3. In the Cox proportional hazard model, the lowest Risk Score1 category, namely Risk Score1≦3.9, served as the reference category; that is, calculated hazard ratios were relative to this lowest category. For this analysis, the predictor variable in the statistical model was the categorized Risk Score1. Analysis of the competing risk Cox proportional hazard model yielded a hazard ratio for the highest score category, namely Risk Score1>5.3, relative to the reference Risk Score1 category, of 2.85 (95% confidence interval of 1.65 to 4.99), with a P-value of 0.00019. The corresponding hazard ratio for the middle score category, namely Risk Score1>3.9 and ≦5.3, relative to the reference Risk Score1 category, was 1.76 (95% confidence interval of 1.01 to 116), with a P-value 0.04269. These results correspond to a finding that individuals with a Risk Score1 value >5.3 have a 2.85 times higher risk of a coronary artery revascularization procedure after baseline measurement and compared to individuals with a Risk Score1≦3.9, and that individuals with a Risk Score1 value >3.9 and ≦5.3 have a 1.76 times higher risk of a coronary artery revascularization procedure compared to individuals with a Risk Score1≦3.9.

As such, the risk score, Risk Score1, is determined to be predictive of the occurrence of a coronary artery revascularization procedure, with higher risk scores associated with higher probability of a coronary artery revascularization procedure.

In addition, a second risk score was calculated using the concentrations of the following eight analytes: apolipoprotein A1 (APOA), apolipoprotein B (APOB), beta-2-microglobulin (B2M), carcinoembryonic antigen (CEA), C-reactive protein ((RP), lipoprotein(a) (LPA), transferrin (TRF), and NT-proBNP. The following equation was used to calculate the risk score:

“Risk Score2”=2.5*(−5.7696156−1.0738*In(APOA)+0.9457*ln(APOB)+0.7044*ln(B2M)+0.0967*ln(CRP)+1.1465*ln(TRF)+0.3416*ln(NT-proBNP)+a_{LPA}+a_{CEA})
where

| a_{LPA} is: | if LPA measurement value is: | |
|---|---|---|
| 0 | ≦3.2 | mg/dL |
| 0.5252 | >3.2 and ≦6.9 | mg/dL |
| 0.3387 | >6.9 and ≦11.4 | mg/dL |
| 0.3899 | >11.4 and ≦28.3 | mg/dL |
| 0.6686 | >28.3 | mg/dL |

and

| a_{CEA} is: | if CEA measurement value is: | |
|---|---|---|
| 0 | ≦1.01 | ng/mL |
| 0.1659 | >1.01 and ≦1.43 | ng/mL |
| 0.00863 | >1.43 and ≦1.93 | ng/mL |
| 0.3552 | >1.93 and ≦2.83 | ng/mL |
| 0.5990 | >2.83 | ng/mL |

In the above formula, each analyte abbreviation indicates its measured concentration in the indicated measurement units of Table 1, “ln” indicates natural logarithm, and “*” indicates multiplication. The risk score is a dimensionless real number.

A risk score, referred to herein as “Risk Score2,” was calculated for each of the 6,600 individuals in the study, using measurements from each subject's baseline blood plasma specimen.

The value of Risk Score2 was found to be statistically significantly different between the 117 subjects underwent a coronary artery revascularization procedure at some time, and the remaining 6,483 subjects who did not undergo a coronary artery revascularization procedure. The distribution of Risk Score2 values was as follows (Table 3).

TABLE 3

| | | Standard |
|---|---|---|
| | Mean | deviation |
| Subjects who did not undergo a | 4.539 | 1.546 |
| coronary artery revascularization | | |
| procedure | | |
| Subjects who did undergo a | 5.362 | 1.625 |
| Coronary artery revascularization | | |
| procedure | | |

A two-sided Student t-test for the difference in mean values of the risk score yielded a t value of −5,700 and 6,590 degrees of freedom, and a p-value <0.0001.

Statistical Cox proportional hazard modeling was used to determine the instantaneous hazard of the occurrence of a coronary artery revascularization procedure at any time per one unit increase in the calculated risk score, Risk Score2. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the competing risk Cox proportional hazard model yielded a hazard ratio for the score of 1.33 per unit increase of the score (95% confidence interval of 1.15 to 1.53), with a P-value of 0.000074.

In addition, a statistical Cox proportional hazard model was evaluated with the Risk Score2 categorized into three categories. The ranges of Risk Score2 that defined the three categories were as follows: (i) Risk Score2≦3.9; (ii) Risk Score2>3.9 and ≦5.3; (iii) Risk Score2>5.3. In the Cox proportional hazard model, the lowest Risk Score2 category, namely Risk Score2≦3.9, served as the reference category; that is, calculated hazard ratios were relative to this lowest category. For this analysis, the predictor variable in the statistical model was the categorized Risk Score2, Analysis of the competing risk Cox proportional hazard model yielded a hazard ratio for the highest score category, namely Risk Score2>5.3, relative to the reference Risk Score2 category, of 3.59 (95% confidence interval of 1.95 to 6.63), with a P-value of 0.000043. The corresponding hazard ratio for the middle score category, namely Risk Score2>3.9 and ≦5.3, relative to the reference Risk Score2 category, of 2.10 (95% confidence interval of 1.15 to 3.95), with a P-value of 0.0215, These results correspond to a finding that individuals with a Risk Score2 value >5.3 have a 3.59 times higher risk of a coronary artery revascularization procedure after baseline measurement compared to individuals with a Risk Score2≦3.9, and that individuals with a Risk Score2 value >3.9 and ≦5.3 have a 2.10 times higher risk of a coronary artery revascularization procedure compared to individuals with a Risk Score2≦3.9.

As such, this second risk score, Risk Score2, is determined to be predictive of the occurrence of a coronary artery revascularization procedure, with higher risk scores associated with higher probability of a coronary artery revascularization procedure.

Therefore, biomarker panels comprising apolipoprotein A1, apolipoprotein B, beta-2microgiobulin, carcinoembryonic antigen, C-reactive protein, lipoprotein(a) and transferrin, and optionally N-terminal pro B-type natriuretic peptide (NT-proBNP), are useful for predicting whether a human is at risk for being a candidate for and/or for needing a coronary revascularization procedure.

### EXAMPLE 2

### Blood Plasma Analytes for Prediction of Risk for Hospitalization for Unstable Angina

The clinical study population, biochemical measurements, and clinical measurements are as described in Example 1. As described in Example 1, a risk score, Risk Score1, calculated from a biomarker panel comprising the analytes apolipoprotein A1, apolipoprotein B, beta-2-microglobulin, carcinoembryonic antigen, C-reactive protein, lipoprotein(a) and transferrin, was calculated for each subject in the clinical study.

During the follow-up period of the clinical study, 79 subjects were hospitalized for unstable angina. Statistical Cox proportional hazard modeling was used to determine the instantaneous hazard of the occurrence of a hospitalization for unstable angina at any time associated with each one unit increase in the calculated risk score, Risk Score1. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for Risk Score1 of 1.18 (95% confidence interval of 1.01 to 1.40) per unit increase of the score, with a P-value of 0.0310.

In addition, a statistical Cox proportional hazard model was evaluated with the Risk Score1 categorized into three categories. The ranges of Risk Score1 that defined the three categories were as follows: (i) Risk Score1≦3.9; (ii) Risk Score1>3.9 and ≦5.3; (iii) Risk Score1>5.3. In the Cox proportional hazard model, the lowest Risk Score1 category, namely Risk Score1≦3.9, served as the reference category; that is, calculated hazard ratios were relative to this lowest category. For this analysis, the predictor variable in the statistical model was the categorized Risk Score1. Analysis of the competing risk Cox proportional hazard model yielded a hazard ratio for the highest score category, namely Risk Score1>5.3, relative to the reference Risk Score1 category, of 2.95 (95% confidence interval of 1.70 to 5.11), with a P-value of 0.00012. The corresponding hazard ratio for the middle score category, namely Risk Score1>3.9 and ≦5.3, relative to the reference Risk Score1 category, was 1.59 (95% confidence interval of 1.02 to 3.24), with a P-value of 0.0254. These results correspond to a finding that individuals with a Risk Score1 value >5.3 have a 2.95 times higher risk of a hospitalization for unstable angina after baseline measurement compared to individuals with a Risk Score1≦3.9, and that individuals with a Risk Score1 value >3.9 and ≦5.3 have a 1.59 times higher risk of a hospitalization for unstable angina compared to individuals with a Risk Score1≦3.9,

As such, this risk score, Risk Score1, is determined to be predictive of the risk for hospitalization for unstable angina, with higher risk scores associated with higher probability of hospitalization for unstable angina.

In addition, a risk score, Risk Score2, calculated from a biomarker panel comprising the analytes apolipoprotein A1, apolipoprotein B, beta-2-microglobulin, carcinoembryonic antigen, C-reactive protein, lipoprotein(a), transferrin and NT-proBNP, was calculated for each subject in the clinical study.

Statistical Cox proportional hazard modeling was used to determine the instantaneous hazard of the occurrence of a hospitalization for unstable angina at any time associated with each one unit increase in the calculated risk score, Risk Score2. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.19 (95% confidence interval of 1.01 to 1.40) per unit increase of the score, with a P-value of 0.0367.

In addition, a statistical Cox proportional hazard model was evaluated with the Risk Score2 categorized into three categories. The ranges of Risk Score2 that defined the three categories were as follows: (i) Risk Score2≦3.9; (ii) Risk Score2>3.9 and ≦5.3; (iii) Risk Score2>5.3. In the Cox proportional hazard model, the lowest Risk Score2 category, namely Risk Score2≦3.9, served as the reference category; that is, calculated hazard ratios were relative to this lowest category. For this analysis, the predictor variable in the statistical model was the categorized Risk Score2. Analysis of the competing risk Cox proportional hazard model yielded a hazard ratio for the highest score category, namely Risk Score2>5.3, relative to the reference Risk Score2 category, of 4.78 (95% confidence interval 2.50 to 9.13), with a P-value of 0.000002. The corresponding hazard ratio for the middle score category, namely Risk Score2>3.9 and ≦5.3, relative to the reference Risk Score2 category, was 2.06 (95% confidence interval of 1.03 to 4.09), with a P-value of 0.040. These results correspond to a finding that individuals with a Risk Score2 value >5.3 have a 4.78 times higher risk of a hospitalization for unstable angina after baseline measurement compared to individuals with a Risk Score2≦3.9, and that individuals with a Risk Score2 value >3.9 and ≦5.3 have a 2.06 times higher risk of a hospitalization for unstable angina compared to individuals with a Risk Score2

As such, this second risk score, Risk Score2, is determined to be predictive of the risk for hospitalization for unstable angina, with higher risk scores associated with higher probability of a hospitalization for unstable angina.

Therefore, biomarker panels comprising apolipoprotein A1, apolipoprotein B, beta-2-microglobulin, carcinoembryonic antigen, C-reactive protein, lipoprotein(a) and transferrin, and optionally N-terminal pro B-type natriuretic peptide (NT-proBNP), are useful for predicting whether a human is at risk for being a candidate for hospitalization for unstable angina.

### EXAMPLE 3

### Blood Plasma Analytes for Prediction of Risk for Ischemic Stroke

The clinical study population, biochemical measurements, and clinical measurements are as described in Example 1. As described in Example 1, a risk score, Risk Score1, calculated from a biomarker panel comprising the analytes apolipoprotein A1, apolipoprotein B, beta-2-microglobulin, carcinoembryonic antigen, C-reactive protein, lipoprotein(a) and transferrin, was calculated for each subject in the clinical study.

During the follow-up period of the clinical study, 59 subjects experienced an ischemic stroke. Statistical Cox proportional hazard modeling was used to determine the instantaneous hazard of the occurrence of an ischemic stroke at any time associated with each one unit increase in the calculated risk score, Risk Score1. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.30 (95% confidence interval of 1.07 to 1.58) per unit increase of the score, with a P-value of 0.0072.

In addition, a statistical Cox proportional hazard model was evaluated with the Risk Score1 categorized into three categories. The ranges of Risk Score1 that defined the three categories were as follows: (i) Risk Score1≦3.9; (ii) Risk Score1>3.9 and ≦5.3; (iii) Risk Score1>5.3, In the Cox proportional hazard model, the lowest Risk Score1 category, namely Risk Score1≦3.9, served as the reference category; that is, calculated hazard ratios were relative to this lowest category. For this analysis, the predictor variable in the statistical model was the categorized Risk Score1. Analysis of the competing risk Cox proportional hazard model yielded a hazard ratio for the highest score category, namely Risk Score1>5.3, relative to the reference Risk Score1 category, of 2.94 (95% confidence interval of 1.70 to 5.11), with a P-value of 0.00012. The corresponding hazard ratio for the middle score category, namely Risk Score1>3.9 and ≦5.3, relative to the reference Risk Score1 category, of 1.59 (95% confidence interval of 1.02 to 3.12), with a P-value of 0.032, These results correspond to a finding that individuals with a Risk Score1 value >5.3 have a 2.94 times higher risk of ischemic stroke after baseline measurement compared to individuals with a Risk Score1≦3.9, and that individuals with a Risk Score1 value >3.9 and ≦5.3 have a 1.59 times higher risk of ischemic stroke compared to individuals with a Risk Score1≦3.9.

As such, this risk score, Risk Score1, is determined to be predictive of the risk for ischemic stroke, with higher risk scores associated with higher probability of an ischemic stroke.

In addition, a risk score, Risk Score2, calculated from a biomarker panel comprising the analytes apolipoprotein A1, apolipoprotein B, beta-2-microglobulin, carcinoembryonic antigen, C-reactive protein, lipoprotein(a), transferrin and NT-proBNP, was calculated for each subject in the clinical study.

Statistical Cox proportional hazard modeling was used to determine the instantaneous hazard of the occurrence of a ischemic stroke at any time associated with each one unit increase in the calculated risk score, Risk Score2. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.45 (95% confidence interval of 1.22 to 1.74) per unit increase of the score, with a P-value of 0.00003.

In addition, a statistical Cox proportional hazard model was evaluated with the Risk Score2 categorized into three categories. The ranges of Risk Score2 that defined the three categories were as follows: (i) Risk Score2≦3.9; (ii) Risk Score2>3.9 and ≦5.3; (iii) Risk Score2>5.3. In the Cox proportional hazard model, the lowest Risk Score2 category, namely Risk Score2≦3.9, served as the reference category; that is, calculated hazard ratios were relative to this lowest category. For this analysis, the predictor variable in the statistical model was the categorized Risk Score2. Analysis of the competing risk Cox proportional hazard model yielded a hazard ratio for the highest score category, namely Risk Score2>5.3, relative to the reference Risk Score2 category, of 4.78 (95% confidence interval of 2.50 to 9.13), with a P-value of 0,000002. The corresponding hazard ratio for the middle score category, namely Risk Score2>3.9 and ≦5.3, relative to the reference Risk Score2 category, was 2.06 (95% confidence interval of 1.03 to 4.09), with a P-value of 0.0401. These results correspond to a finding that individuals with a Risk Score2 value >5.3 have a 4.78 times higher risk of a ischemic stroke after baseline measurement compared to individuals with a Risk Score2≦3.9, and that individuals with a Risk Score2 value >3,9 and ≦5.3 have a 2.06 times higher risk ischemic stroke compared to individuals with a Risk Score2≦3.9.

As such, this second risk score, Risk Score2, is determined to be predictive of the risk for ischemic stroke, with higher risk scores associated with higher probability of an ischemic stroke.

Therefore, biomarker panels comprising apolipoprotein A1, apolipoprotein B, beta-2-microglobulin, carcinoembryonic antigen, C-reactive protein, lipoprotein(a) and transferrin, and optionally N-terminal pro B-type natriuretic peptide (NT-proBNP), are useful for predicting whether a human is at risk for experiencing an ischemic stroke.

### EXAMPLE 4

### Blood Plasma Analytes for Prediction of Risk for Heart Failure

The clinical study population, biochemical measurements, and clinical measurements are as described in Example 1. As described in Example 1, a risk score, Risk Score1, calculated from a biomarker panel comprising the analytes apolipoprotein A1, apolipoprotein B, beta-2-microglobulin, carcinoembryonic antigen, C-reactive protein, lipoprotein(a) and transferrin, was calculated for each subject in the clinical study.

During the follow-up period of the clinical study, 103 subjects developed heart failure as diagnosed by a physician. Statistical Cox proportional hazard modeling was used to determine the instantaneous hazard of the occurrence of heart failure at any time associated with each one unit increase in the calculated risk score, Risk Score1. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.44 (95% confidence interval of 1.25 to 1.66) per unit increase of the score, with a P-value of <0.0001.

In addition, a statistical Cox proportional hazard model was evaluated with the Risk Score1 categorized into three categories. The ranges of Risk Score1 that defined the three categories were as follows: (i) Risk Score1≦3.9; (ii) Risk Score1>3.9 and ≦5.3; (iii) Risk Score1>5.3. In the Cox proportional hazard model, the lowest Risk Score1 category, namely Risk Score1≦3.9, served as the reference category; that is, calculated hazard ratios were relative to this lowest category. For this analysis, the predictor variable in the statistical model was the categorized Risk Score1. Analysis of the competing risk Cox proportional hazard model yielded a hazard ratio for the highest score category, namely Risk Score1>5.3, relative to the reference Risk Score1 category, of 2.84 (95% confidence interval of 1.70 to 4.73), with a P-value of <0.0001. The corresponding hazard ratio for the middle score category, namely Risk Score1>3.9 and ≦5.3, relative to the reference Risk Score1 category, was 1.57 (95% confidence interval of 1.01 to 4.03), with a P-value of 0.0438. These results correspond to a finding that individuals with a Risk Score1 value >5.3 have a 2.84 times higher risk of developing heart failure after baseline measurement compared to individuals with a Risk Score1≦3.9, and that individuals with a Risk Score1 value >3.9 and 5.3 have a 1.57 times higher risk of developing heart failure compared to individuals with a Risk Score1≦3.9.

As such, this risk score, Risk Score1, is determined to be predictive of the risk for developing heart failure, with higher risk scores associated with higher probability of heart failure.

in addition, a risk score, Risk Score2, calculated from a biomarker panel comprising the analytes apolipoprotein A1, apolipoprotein B, beta-2-microglobulin, carcinoembryonic antigen, C-reactive protein, lipoprotein(a), transferrin and NT-proBNP, was calculated for each subject in the clinical study.

Statistical Cox proportional hazard modeling was used to determine the instantaneous hazard of the occurrence of heart failure at any time associated with each one unit increase in the calculated risk score, Risk Score2. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.67 (95% confidence interval of 1.46 to 1.90) per unit increase of the score, with a P-value <0.0001.

In addition, a statistical Cox proportional hazard model was evaluated with the Risk Score2 categorized into three categories. The ranges of Risk Score2 that defined the three categories were as follows: (i) Risk Score2≦3.9; (ii) Risk Score2>3.9 and ≦5.3; (iii) Risk Score2>5.3. In the Cox proportional hazard model, the lowest Risk Score2 category, namely Risk Score2≦3.9, served as the reference category; that is, calculated hazard ratios were relative to this lowest category. For this analysis, the predictor variable in the statistical model was the categorized. Risk Score2. Analysis of the competing risk Cox proportional hazard model yielded a hazard ratio for the highest score category, namely Risk Score2>5.3, relative to the reference Risk Score2 category, of 4.32 (95% confidence interval of 2.56 to 7.29), with a P-value of <0.0001. The corresponding hazard ratio for the middle score category, namely Risk Score2>3.9 and ≦5.3, relative to the reference Risk Score2 category, was 1.24 (95% confidence interval of 1.01 to 4.83), with a P-value of 0.0449, These results correspond to a finding that individuals with a Risk Score2 value >5.3 have a 4.32 times higher risk of developing heart failure after baseline measurement compared to individuals with a Risk Score2≦3,9, and that individuals with a Risk Score2 value >3.9 and ≦5.3 have a 1.24 times higher risk of developing heart failure compared to individuals with a Risk Score2≦3.9.

As such, this second risk score, Risk Score2, is determined to be predictive of the risk of developing heart failure, with higher risk scores associated with higher probability of developing heart failure.

Therefore, biomarker panels comprising apolipoprotein A1, apolipoprotein B, beta-2-microglobulin, carcinoembryonic antigen, C-reactive protein, lipoprotein(a) and transferrin, and optionally N-terminal pro B-type natriuretic peptide (NT-proBNP), are useful for predicting whether an human is at risk for developing heart failure.

### Example 5

### Blood Plasma Analytes for Prediction of Risk for Mortality

The clinical study population, biochemical measurements, and clinical measurements are as described in Example 1. As described in Example 1, a risk score, Risk Score1, calculated from a biomarker panel comprising the analytes apolipoprotein A1, apolipoprotein B, beta-2-microglobulin, carcinoembryonic antigen, C-reactive protein, lipoprotein(a) and transferrin, was calculated for each subject in the clinical study.

During the follow-up period of the clinical study, 97 subjects died. Statistical Cox proportional hazard modeling was used to determine the instantaneous hazard of death at any time associated with each one unit increase in the calculated risk score, Risk Score1. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.44 (95% confidence interval of 1.27 to 1.63) per unit increase of the score, with a P-value of <0.0001.

In addition, a statistical Cox proportional hazard model was evaluated with the Risk Score1 categorized into three categories. The ranges of Risk Score1 that defined the three categories were as follows: (i) Risk Score1≦3.9; (ii) Risk Score1>3.9 and ≦5.3; (iii) Risk Score1>5.3. In the Cox proportional hazard model, the lowest Risk Score1 category, namely Risk Score1≦3.9, served as the reference category; that is, calculated hazard ratios were relative to this lowest category. For this analysis, the predictor variable in the statistical model was the categorized Risk Score1. Analysis of the competing risk Cox proportional hazard model yielded a hazard ratio for the highest score category, namely Risk Score1>5.3, relative to the reference Risk Score1 category, of 2.95 (95% confidence interval of 1.70 to 5.11), with a P-value of <0.0001. The corresponding hazard ratio for the middle score category, namely Risk Score1>3.9 and ≦5.3, relative to the reference Risk Score1 category, was 1.59 (95% confidence interval of 1.00 to 2.93), with a P-value of 0.0532. These results correspond to a finding that individuals with a Risk Score1 value >5.3 have a 2.95 times higher risk of death after baseline measurement compared to individuals with a Risk Score1≦3.9, and that individuals with a Risk Score1 value >3.9 and ≦5.3 have a 1.59 times higher risk of death compared to individuals with a Risk Score1≦3.9.

As such, this risk score, Risk Score1, is determined to be predictive of the risk for death, with higher risk scores associated with higher probability of death.

In addition, a risk score, Risk Score2, calculated from a biomarker panel comprising the analytes apolipoprotein A1, apolipoprotein B, beta-2-microglobulin, carcinoembryonic antigen, C-reactive protein, lipoprotein(a), transferrin and NT-proBNP, was calculated for each subject in the clinical study.

Statistical Cox proportional hazard modeling was used to determine the instantaneous hazard or death at any time associated with each one unit increase in the calculated risk score, Risk Score2. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.52 (95% confidence interval of 1.33 to 1.74) per unit increase of the score, with a P-value <0.0001.

In addition, a statistical Cox proportional hazard model was evaluated with the Risk Score2 categorized into three categories. The ranges of Risk Score2 that defined the three categories were as follows: (i) Risk Score2<3.9; (ii) Risk Score2>3.9 and <5.3; (iii) Risk Score2>5.3. In the Cox proportional hazard model, the lowest Risk Score2 category, namely Risk Score2<3.9, served as the reference category; that is, calculated hazard ratios were relative to this lowest category. For this analysis, the predictor variable in the statistical model was the categorized Risk Score2. Analysis of the competing risk Cox proportional hazard model yielded a hazard ratio for the highest score category, namely Risk Score2>5.3, relative to the reference Risk Score2 category, of 3.96 (95% confidence interval of 2.26 to 6.92), with a P-value of <0.0001. The corresponding hazard ratio for the middle score category, namely Risk Score2>3.9 and <5.3, relative to the reference Risk Score2 category, was 1.77 (95% confidence interval of 1.01 to 3.27), with a P-value of 0.0311. These results correspond to a finding that individuals with a Risk Score2 value >5.3 have a 3.96 times higher risk of death after baseline measurement compared to individuals with a Risk Score2<3.9, and that individuals with a Risk Score2 value >3.9 and <5.3 have a 1.77 times higher risk of death compared to individuals with a Risk Score2<3.9.As such, this second risk score, Risk Score2, is determined to be predictive of the risk of death, with higher risk scores associated with higher probability of death.

Therefore, biomarker panels comprising apolipoprotein A1, apolipoprotein B, beta-2-microglobulin, carcinoembryonic antigen, C-reactive protein, lipoprotein(a) and transferrin, and optionally N-terminal pro B-type natriuretic peptide (NT-proBNP), are useful for predicting whether an human is at risk for death.

### EXAMPLE 6

### Blood Plasma Analytes for Prediction of Risk for All-Cause Stroke

The clinical study population, biochemical measurements, and clinical measurements are as described in Example 1. As described in Example 1, a risk score, Risk Score 1, calculated from a biomarker panel comprising the analytes apolipoprotein A1, apolipoprotein B, beta-2-microglobulin, carcinoembryonic antigen, C-reactive protein, lipoprotein(a) and transferrin, was calculated for each subject in the clinical study.

During the follow-up period of the clinical study, 71 subjects experienced all-cause stroke. All-cause stroke includes hemorrhagic stroke, ischemic stroke, and transient ischemic attack. Statistical Cox proportional hazard modeling was used to determine the instantaneous hazard of all-cause stroke at any time associated with each one unit increase in the calculated risk score, Risk Score1. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.27 (95% confidence interval of 1.06 to 1.51) per unit increase of the score, with a P-value of 0.008.

In addition, a statistical Cox proportional hazard model was evaluated with the Risk Score1 categorized into three categories. The ranges of Risk Score1 that defined the three categories were as follows: (i) Risk Score1≦3.9; (ii) Risk Score1>3.9 and ≦5.3; (iii) Risk Score1>5.3. In the Cox proportional hazard model, the lowest Risk Score1 category, namely Risk Score1≦3.9, served as the reference category; that is, calculated hazard ratios were relative to this lowest category. For this analysis, the predictor variable in the statistical model was the categorized Risk Score1 Analysis of the competing risk Cox proportional hazard model yielded a hazard ratio for the highest score category, namely Risk Score1>5.3, relative to the reference Risk Score1 category, of 1.90 (95% confidence interval of 1.06 to 3.42), with a P-value of 0.032. The corresponding hazard ratio for the middle score category, namely Risk Score1>3.9 and ≦5.3, relative to the reference Risk Score1 category, was 1.17 (95% confidence interval of 0.86 to 2.21), with a P-value of 0.13. These results correspond to a finding that individuals with a Risk Score1 value >5.3 have a 1.90 times higher risk of all-cause stroke after baseline measurement compared to individuals with a Risk Score1≦3.9, and that individuals with a Risk Score1 value >3.9 and ≦5.3 have a 1.17 times higher risk of all-cause stroke compared to individuals with a Risk Score1≦3.9.

As such, this risk score, Risk Score1, is determined to be predictive of the risk for all-cause stroke, with higher risk scores associated with higher probability of all-cause stroke.

In addition, a risk score, Risk Score2, calculated from a biomarker panel comprising the analytes apolipoprotein A1, apolipoprotein B, beta-2-microglobulin, carcinoembryonic antigen, C-reactive protein, lipoprotein(a), transferrin and NT-proBNP, was calculated for each subject in the clinical study.

Statistical Cox proportional hazard modeling was used to determine the instantaneous hazard of all-cause stroke at any time associated with each one unit increase in the calculated risk score, Risk Score2. In the Cox proportional hazard model, in addition to the risk score, the following covariates were included, all evaluated at baseline: age (in years), gender, total cholesterol, low-density lipoprotein cholesterol, high-density lipoprotein cholesterol, total triglycerides, systolic blood pressure, diastolic blood pressure, current smoking status, presence or absence of diabetes mellitus, and body mass index. Analysis of the Cox proportional hazard model yielded a hazard ratio for the score of 1.35 (95% confidence interval of 1.15 to 1.59) per unit increase of the score, with a P-value <0.0001.

In addition, a statistical Cox proportional hazard model was evaluated with the Risk Score2 categorized into three categories. The ranges of Risk Score2 that defined the three categories were as follows: (i) Risk Score2≦3.9; (ii) Risk Score2>3.9 and ≦5.3; Oh) Risk Score2>5.3. In the Cox proportional hazard model, the lowest Risk Score2 category, namely Risk Score2≦3.9, served as the reference category; that is, calculated hazard ratios were relative to this lowest category. For this analysis, the predictor variable in the statistical model was the categorized Risk Score2. Analysis of the competing risk Cox proportional hazard model yielded a hazard ratio for the highest score category, namely Risk Score2>5.3, relative to the reference Risk Score2 category, of 3.13 (95% confidence interval of 1.73 to 5.68), with a P-value of <0.0001. The corresponding hazard ratio for the middle score category, namely Risk Score2>3.9 and ≦5.3, relative to the reference Risk Score2 category, was 1.15 (95% confidence interval of 1.00 to 2.30), with a P-value of 0.0511. These results correspond to a finding that individuals with a Risk Score2 value >5.3 have a 3.13 times higher risk of all-cause stroke after baseline measurement compared to individuals with a Risk Score2≦3.9, and that individuals with a Risk Score2 value >3.9 and ≦5.3 have a 1.15 times higher risk of all-cause stroke compared to individuals with a Risk Score2≦3.9,As such, this second risk score, Risk Score2, is determined to be predictive of the risk of all-cause stroke, with higher risk scores associated with higher probability of all-cause stroke.

Therefore, biomarker panels comprising apolipoprotein A1, apolipoprotein B, beta-2-microglobulin, carcinoembryonic antigen, C-reactive protein, lipoprotein(a) and transferrin, and optionally N-terminal pro B-type natriuretic peptide (NT-proBNP), are useful for predicting whether an human is at risk for all-cause stroke.

What is claimed is:

1. A method of diagnosing the risk of an adverse event in a human, the method comprising:
measuring the levels of a set of biomarkers in a sample from a human, wherein the set of biomarkers comprises carcinoembryonic antigen (CEA), beta-2 microglobulin, C-reactive protein (CRP), apolipoprotein A1 (ApoA1), apolipoprotein B (ApoB), transferrin, and lipoprotein(a);
calculating a risk score for the human, wherein calculating the risk score comprises weighting the measured levels of biomarkers; and
using the risk score to identify a likelihood that the human will experience an adverse event, wherein the adverse event is selected from unstable angina, ischemic stroke, non-ischemic stroke, all-cause stroke, heart failure, all-cause death, and being a candidate for coronary revascularization surgery.

2. (canceled)

3. A method of diagnosing the risk of an adverse event in a human, the method comprising:
inputting into a computer including a computer readable medium measurements of the levels of a set of biomarkers in a sample obtained from a human, wherein the set of biomarkers comprises carcinoembryonic antigen (CEA), beta-2 microglobulin, C-reactive protein (CRP), apolipoprotein A1 (ApoA1), apolipoprotein B (ApoB), transferrin, and lipoprotein(a); and
causing the computer to calculate a risk score for the human, wherein calculating comprises weighting measured levels of biomarkers, thereby determining the risk of an adverse event in the human, wherein the adverse event is selected from unstable angina, ischemic stroke, non-ischemic stroke, all-cause stroke, heart failure, all-cause death, and being a candidate for coronary revascularization surgery.

4. The method of claim 3, wherein the set of biomarkers comprises N-terminal pro B-type natriuretic peptide (NT-proBNP).

5. The method of claim 3, comprising the step of transmitting, displaying, storing, or printing; or outputting to a user interface device, a computer readable storage medium, a local computer system or a remote computer system, information related to the likelihood of an adverse event in the human.

6. The method of claim 5, wherein the information is the risk score or an equivalent thereof.

7. The method of claim 3, comprising recommending, authorizing, or administering treatment if the individual is identified as having an increased likelihood of experiencing an adverse event.

8. The method of claim 3, comprising identifying the human as having an increased likelihood of having an adverse event if the risk score is greater than a reference risk score, and identifying the human as having a decreased likelihood of having an adverse event if the risk score is less than the reference risk score.

9. The method of claim 10, wherein the reference risk score is a standard or a threshold, optionally comprising an upper limit and a lower limit.

10. The method of claim 3, wherein the calculating is performed using a suitably programmed computer.

11. (canceled)

12. The method of claim 3, wherein the sample comprises blood.

13. The method of claim 3, wherein the risk is a near-term risk.

14. The method of claim 3, wherein the risk score further comprises at least one of a weighted metric of the human's age and of clinical risk factors for the human, wherein the clinical risk factors are selected from the group consisting of current smoking status, presence of diabetes mellitus, systolic blood pressure, diastolic blood pressure, body mass index, total cholesterol, HDL cholesterol, and LDL cholesterol.

15. A computer storage medium including program instructions for use in performing a method of diagnosing the risk of an adverse event in a human, wherein execution of the program instructions by one or more processors of a computer system causes the one or more processors to carry out the step of calculating a risk score for a human based on the measured levels of a set of biomarkers from a sample obtained from a human, thereby to identify the risk of an adverse event in the human,
wherein calculating comprises weighting measured levels of biomarkers of the set of biomarkers and summing the weighted measured levels,
the set of biomarkers comprises carcinoembryonic antigen (CEA), beta-2 microglobulin, C-reactive protein (CRP), apolipoprotein A1 (ApoA1), apolipoprotein B (ApoB), transferrin, and lipoprotein(a), and
the adverse event is selected from unstable angina, ischemic stroke, non-ischemic stroke, all-cause stroke, heart failure, all-cause death, and being a candidate for coronary revascularization surgery.

16. (canceled)

17. The computer storage medium of claim 15, wherein the set of biomarkers comprises N-terminal pro B-type natriuretic peptide (NT-proBNP).

18. The computer storage medium of claim 15, wherein execution of the program instructions causes transmitting, displaying, storing, or printing; or outputting to a user interface device, a computer readable storage medium, a local computer system or a remote computer system, information related to the likelihood of an adverse event in the human.

19. (canceled)
